(19) United States
(12) Patent Application Publication
(10) Pub. No.: US 2015/0269476 A1
(43) Pub. Date: Sep. 24, 2015

(54) SIMPLIFIED ELECTRONIC MODULE FOR A SMART CARD WITH A DUAL COMMUNICATION INTERFACE

(71) Applicant: SMART PACKAGING SOLUTIONS, Rousset (FR)

(72) Inventors: Bernard Calvas, Marseille (FR); Halim Bousmaha, Saint Anthonin sur Bayon (FR)

(73) Assignee: SMART PACKAGING SOLUTIONS, Rousset (FR)

(21) Appl. No.: 14/435,680

(22) PCT Filed: Oct. 14, 2013
(86) PCT No.: PCT/FR2013/000269

§ 371 Date: Apr. 14, 2015

(30) Foreign Application Priority Data
Oct. 15, 2012 (FR) FR1202740

(51) Int. Cl. G06K 19/077

(52) U.S. Cl. CPC G06K 19/07769; G06K 19/07754; G06K 19/07773

(57) ABSTRACT

An electronic module with a dual contact and contactless communication interface, has, on a first face, an electric contact terminal for contact with corresponding contacts of a smart card reader, and, on a second face, an antenna with a coil and a microelectronic chip coated with insulating resin and provided with a contactless communication interface. The antenna has a proximal connection pad and a distal connection pad to be connected to the corresponding terminals of the contactless communication interface of the chip. The proximal connection pad and distal connection pad of the antenna are arranged inside the encapsulation area by an insulating resin, in such a way as to produce a conductive bridge between each proximal connection pad or distal connection pad and the corresponding terminal of the chip, directly via connection wires between said connection pads and the corresponding terminals of the chip, without using vias.

The invention relates to an electronic module with a dual, contact and contactless communication interface, and to a smartcard incorporating such a module.

### PRIOR ART

Smartcards combining hybrid, contact and contactless operation are already known from the prior art. Most contain a microelectronic module provided with contacts, said module having a radio-frequency communication interface connected to the terminals of an antenna that is itself formed in the body of the card, and not in the module itself.

Thus, most cards with dual communication interfaces according to the prior art consist of:
an electronic module containing a microelectronic chip, a contact connection terminal block intended to be brought into contact with the corresponding terminals of a contact smartcard reader, and two contacts (located on the back face) allowing the antenna to be connected;
a card made of a plastic, containing an antenna; and
an electrically conductive material allowing the electronic module and the antenna to be connected.

This structure frequently leads to a series of problems with production of the mechanical connection between the antenna and the module, decreasing reliability or manufacturing yield.

The methods used to interconnect the module and antenna therefore greatly limit the reliability of the final card. Specifically, mechanical and thermal stresses to which the card is exposed during its use cause the connection between the module and the antenna to break, or the electrical resistance of this connection to greatly increase, decreasing the performance of the card while it is being used.

Therefore, this type of card cannot be guaranteed for very extended periods of use (>5 years for example), thereby limiting the possible applications of this type of card.

To mitigate these manufacturing problems it was considered worthwhile, for another known type of smartcard, to integrate the antenna directly into the microelectronic module, and to then simply implant the module into a smartcard body, this being easy to achieve at low cost and with a high degree of reliability with most conventional chip-implanting machines used in the manufacture of contact smartcards.

However, a residual problem is encountered, even in the most sophisticated prior-art modules, because the electrical contacts of the terminal block are located on one face of the substrate, and the turns of the antenna are located on the opposite face of the substrate, it thus being necessary to produce metalized vias between the two faces of the substrate in order to connect the terminals of the chip to the electrical contacts of the terminal block of the module, and to the antenna terminals located on the opposite face.

These vias make it possible to form an electrical contact bridge, or “strap”, consisting of two vias connected together by an electrical connection that spans the turns of the antenna and connects the outermost antenna connection pad, i.e. the distal pad, to a proximal connection pad of the antenna, which pad is located near the terminal of the contactless communication interface of the chip. On the one hand, this arrangement makes it possible to use bonding wires of standard loop height and wire length to connect the chip, and, on the other hand, it ensures that the peripheral bonding zone of the module is large enough for it to be possible to subsequently implant the module into a card body.

However, structures employing straps also lead to a series of problems with production of the electronic module.

Specifically, using a substrate containing vias makes the structure expensive since, to produce the vias, it is first necessary to produce holes in the substrate, then to clean the holes and activate the sidewalls thereof with carbon or palladium in order to make them conductive, in order to allow their metalization in a subsequent step, then to finish the via and thus electrically connect the two faces of the substrate.

It is known that metalization of the vias increases copper thickness, possibly by as much as 20 microns on each side of the substrate, this often making a critical difference to these thin products, i.e. smartcard modules.

Furthermore, the steps of producing the vias introduce additional quality control steps and decrease overall manufacturing yield, thereby increasing unit cost relative to a product in which vias are not used.

### AIMS OF THE INVENTION

A general aim of the invention is therefore to provide an electronic module with a dual, contact and contactless communication interface, which does not have the aforementioned drawbacks.

Another aim of the invention is to provide an electronic module with a dual, contact and contactless communication interface that is simpler to manufacture and less expensive than known modules, without decreasing its high level of reliability.

One particular aim of the invention is to provide an electronic module for a smartcard with a dual, contact and contactless communication interface, not requiring vias or interconnects between the faces of the substrate.

### SUMMARY OF THE INVENTION

According to the invention, the electronic module comprises an antenna with a modified design including a zone in which the turns bulge in the direction of the chip and of its droplet of protective resin, the two connection pads of the antenna, namely the distal pad and the proximal pad, both being located under the encapsulating droplet (or under any other equivalent protecting or encapsulating means), thereby allowing the terminals of the contactless interface of the chip to be connected to the connection pads of the antenna without the need for metalized vias or any other type of electrical connection between the faces of the film.

Thus, the contactless function of the module is exclusively located on the front face of the module, which supports the antenna, the chip and their interconnects, the ISO 7816 contacts being located on the opposite face.

Therefore, one subject of the invention is an electronic module with a dual, contact and contactless communication interface, especially for a smartcard, said module comprising a substrate having, on a first face, an electrical contact terminal block enabling operation via contact with corresponding contacts of a smartcard reader, and comprising, on a second face, an antenna provided with at least one turn, and a microelectronic chip located in an encapsulation zone and provided with a contactless communication interface, said antenna comprising a proximal connection pad and a distal connection pad intended to be connected to corresponding terminals of said contactless communication interface of the chip, characterized in that the two, proximal and distal, connection pads of the antenna are arranged inside the encapsulation zone, so as to achieve a direct electrical connection between each of the proximal or distal connection pads and the corresponding terminal of the chip, without using vias, and in that this direct electrical connection is also located in the encapsulation zone of the chip.

According to one variant embodiment of the module, the antenna is at least partially arranged under the chip and the conductive bridge between the proximal and distal connection pads of the antenna is then achieved directly via the chip and via the conductive wires connecting the distal connection pad to the chip, and connecting the chip to the proximal connection pad.

Advantageously, in order to keep the two, proximal and distal, connection pads of the antenna inside the encapsulation zone of the chip, the invention makes provision for the turns of the antenna, which are normally located on the periphery of the module, to contain, in the vicinity of the connection pad that is located furthest from the chip (i.e. the distal pad), a local bulge extending in the direction of the chip, so as to allow said distal connection pad to be connected to the corresponding terminal of the chip, inside the zone protected by the encapsulation.

In this way, the connection zones (pads) of the antenna and the radio-frequency communication function are kept on a single face of the substrate of the module, a strap therefore no longer being required on the other face. This in particular makes it possible to connect directly the contactless interface of the microelectronic chip to the connection pads of the antenna, without using vias or other electrical connections between the two opposite faces of the substrate.

In one variant embodiment, it is possible for the turns of the antenna to themselves lie in the vicinity of the chip on one side of the module, without a localized bulge inward from the periphery of the module in the direction of the chip. In this case, the turns run the risk of covering the bonding holes between the terminals of the contact interface of the chip, and the ISO contacts of the module.

In order to prevent this, the invention provides, in this variant, for the turns to deviate locally in order to bypass said bonding holes produced between the terminals of the contact interface of the chip, and the ISO connection terminals of the module.

According to another advantageous variant of the invention, the turns of the antenna are configured into two bands in series, namely an external band near the periphery of the module and an internal band closer to the chip, at least the internal band being provided with a bulge and a contact terminal located in the encapsulation zone, so as to make it possible to connect to the chip, during production of the module, only the internal band (3i), or the two bands (3i, 3e) of turns.

This ability to connect two bands of turns in series also allows the characteristics of the antenna to be chosen depending on the input impedance of the contactless communication interface of the microelectronic chip.

According to another advantageous variant of the invention, the antenna is partially arranged under the chip, so as to bring the distal connection pad of the antenna closer to the encapsulation zone (especially formed by a droplet of insulating resin) of the chip, so as to obtain a smaller encapsulation area and to decrease the length of the bonding wires connecting the connection pads of the antenna and the terminals of the contactless interface of the chip.

As an additional variant of the invention, the chip may be arranged in a window produced in the thickness of the substrate, so as to obtain a module the thickness of which is smaller than or about equal to the sum of the thicknesses of the chip and of the substrate, thereby allowing the module according to the invention to meet the needs of very thin products, the module then having a thickness smaller than about 350 microns.

Another subject of the invention is a smartcard comprising an electronic module improved and simplified with the above features.

Other features and advantages of the invention will become apparent on reading the following detailed description and from the appended drawings, in which:

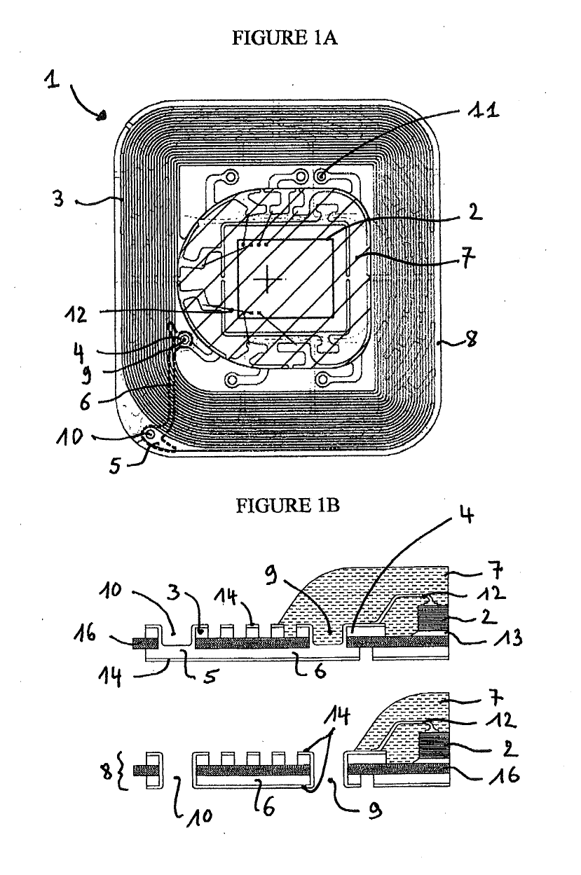

FIGS. 1A and 1B respectively illustrate a plan and cross-sectional view of an electronic module with a dual communication interface according to the prior art, especially for a smartcard;

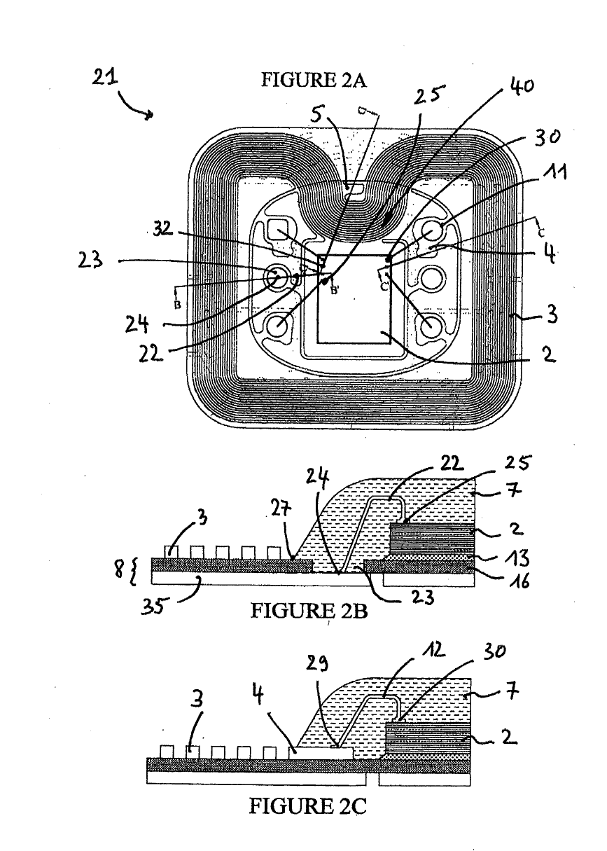

FIGS. 2A and 2B to 2E respectively illustrate a plan view and a number of cross-sectional views of an electronic module with a dual communication interface according to the invention; and

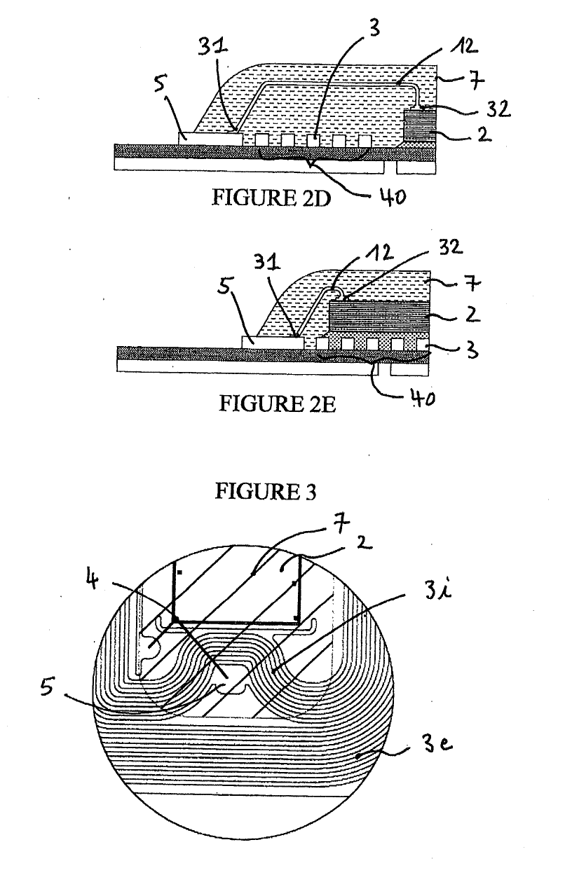

FIG. 3 illustrates a plan view of a variant of the electronic module in FIG. 2.

### DETAILED DESCRIPTION

As indicated above, FIGS. 1A and 1B show a known electronic module 1, including a chip 2 adhesively bonded using an adhesive layer 13 to a substrate 8 comprising an insulating layer 16. The chip 2 is, on the one hand, connected to an electrical contact terminal block (not shown) located on that face of the module which is opposite that bearing the chip, these contacts being intended to interact, in contact mode, with a contact reader. This connection is achieved by way of well-known conductive vias 11 that allow points located on the opposite faces of the module to be electrically connected, and that the present invention seeks to make redundant.

The chip 2 is, on the other hand, connected to an antenna 3 located in a card body or directly on the module, so as to enable radio-frequency communication with a contactless smartcard reader (not shown).

The electrical connection between the antenna and the contact lands provided on the module is achieved by way of connection pads 4, 5 and a conductive track 6, which are made of an electrically conductive material.

The electrical contacts of the terminal block are located on one face of the substrate 8 of the module, and the turns of the antenna 3 of the microelectronic module and the chip 2 are located on the opposite face of the substrate.

As may be seen, the turns of the antenna 3 are in the prior art entirely located on the periphery of the module, thereby allowing the antenna area, and therefore the range of radio-frequency communication between the module 1 and a remote contactless reader, to be maximized.

In this configuration, the connection pads 4, 5 of the antenna 3 are located outside the encapsulation zone 7 (represented by the hatched line) which, in practice, often corresponds to the area of a droplet of insulating resin encapsulating and protecting the chip. The distal connection pad 5 of the antenna, corresponding to the antenna end furthest from the chip, is connected to a via 10, itself connected to a track 6 connected to the proximal connection pad 4 of the antenna (namely the connection pad closest the chip) by way of another via 9. The track 6 thus forms a conductive bridge that passes over the turns of the antenna 3 and allows the distal connection pad of the antenna to be accessed in the vicinity of the terminal of the corresponding chip.

The assembly made up of the track 6 and the two vias 9, 10 therefore forms a conductive bridge that is commonly referred to as a “strap”.

FIG. 1B shows a cross section through the module in FIG. 1, along an imaginary line passing through the vias 9, 10 and the connection pad 6. In the top portion of FIG. 1B, the vias 9, 10 are blind, whereas in the bottom FIG. 1B the vias 9, 10 are through-vias.

The parasitic metal layer 14 due to the production of the metalization vias 9, 10 is also shown.

Furthermore, as was explained above, production of the track 6 and of the vias 9, 10 results in additional cost and a decrease in manufacturing yield, which the invention aims to prevent.

Reference is now made to FIG. 2, corresponding to a number of embodiments of the electronic module according to the invention. These figures show an electronic module 21 according to the invention, seen from above (FIG. 2A), i.e. from the side of the chip and the antenna, and in cross section (FIGS. 2B to 2E) in various cross-sectional planes that allow details of different variants to be seen.

As shown in FIG. 2A, the distal connection pad 5 of the antenna is now located inside the encapsulation zone represented by the line 27.

In order to allow this distal pad 5 to be located in the encapsulation zone, without using vias or straps, the invention makes provision to deviate locally the entire band of turns of the antenna 3 in the vicinity of the distal pad 5, in the direction of the chip. Thus, the antenna 3 contains a localized bulge 40 extending inward from the periphery of the module 21 toward the center of the module, and the turns of the antenna pass locally under the zone of the ISO contacts of the module.

FIG. 2A also shows bonding holes 23, i.e. apertures in the substrate allowing bonding wires 22 to be run between the terminals of the contact interface of the chip and the ISO metal contacts 35 located on the opposite face of the module.

FIG. 2B, which corresponds to a cross section along B-B in FIG. 2A, in particular shows a bonding wire 22 connecting the contact interface 25 of the chip to an ISO contact 35, through a bonding hole 23 produced in the dielectric 16 of the substrate.

FIG. 2C, which corresponds to a cross section along C-C in FIG. 2A, shows a metal bonding wire 12 connecting the contactless interface 30 of the chip 2 and the proximal connection pad 4 of the antenna, namely that connection pad of the antenna which corresponds to the end of the antenna turn that is closest to the chip. As may be seen, this proximal pad 4 is located inside the encapsulation zone 7, so that the wire 12 in question is a simple direct metal wire requiring no via.

FIG. 2D, which corresponds to a cross section along D-D in FIG. 2A, shows a metal bonding wire 12 connecting the contactless interface 32 of the chip and the distal connection pad 5 of the antenna, namely the external connection pad of the antenna, which corresponds to the end of the antenna turn that is furthest from the chip. As may be seen, unlike modules according to the prior art, this distal pad 5 is also located inside the encapsulation zone 7, so that the wire 12 in question is also a direct electrical connection, for example a simple direct metal wire, requiring no via.

This result is obtained by virtue of the bulge 40 in the band of turns inward from the periphery of the module toward the encapsulation zone of the chip, such as may be seen in FIG. 2A.

FIG. 2E shows a similar figure to FIGS. 2B to 2D, the difference being that the band of antenna turns 3 that deviates toward the chip (the bulge 40) extends under the chip 2, thereby allowing the size of the encapsulation zone 7 to be decreased and the bonding wires 12 connecting the antenna and chip to be further shortened.

According to another variant of the invention (not shown) which is recommended for very thin modules, the chip 2 may be arranged in a window produced in the thickness of the substrate 8, so as to obtain a module 21 of thickness smaller than the sum of the thicknesses of the chip 2 and substrate 8.

In FIG. 3, which shows a plan view similar to FIG. 2A, the band of antenna turns 3 is subdivided into two bands in series, namely an external band 3e located on the periphery of the module, and an internal band 3i located between the external band and the encapsulation zone of the chip.

In this variant of the invention, only the internal band 3i contains a bulge, in the direction of the chip, and a distal contact pad 5 located in the encapsulation zone. The antenna used is then, depending on how it is connected, either only the antenna formed by the internal bands of turns, or that formed by the internal and external bands in series.

This especially allows the self-inductance value that is most suitable, depending on the input capacitance of the chip used, to be chosen. This option therefore makes it possible to obtain a module that may be used more flexibly, to assemble physically a number of different types of chip, and to select the electrical properties of the antenna via connection of a suitable number of antenna turns.

### ADVANTAGES OF THE INVENTION

In summary, the invention provides a module, especially a smartcard module, design that is noteworthy in that it makes it possible to decrease the number of interconnections and vias between the faces of the film, while nonetheless allowing the module to be assembled using a conventional assembly method.

This allows the manufacturing cost of modules for smart cards with dual communication interfaces to be decreased and the reliability thereof to be increased as a number of manufacturing steps are no longer required.

1. An electronic module with a dual contact and contactless communication interface, said module comprising:
a substrate having, on a first face, an electrical contact terminal block enabling operation via contact with corresponding contacts of a smartcard reader, and, on a second face, an antenna provided with at least one turn, and
a microelectronic chip protected by an encapsulation zone and provided with a contactless communication interface,
said antenna comprising a proximal connection pad and a distal connection pad for connection to corresponding terminals of said contactless communication interface of the chip, wherein the two, proximal and distal connection pads of the antenna are arranged inside the encapsulation zone, and wherein an electrical connection connects each proximal or distal connection pad of the antenna to the corresponding terminal of the chip, without using vias.

2. The electronic module as claimed in claim 1, wherein the antenna is at least partially arranged under the chip and wherein said electrical connection between the proximal and distal connection pads of the antenna and the corresponding terminals of the antenna is produced directly via the chip and via an electrical connection connecting the distal connection pad to the chip, and the chip to the proximal connection pad.

3. The electronic module as claimed in claim 1, wherein the turns of the antenna are located on the periphery of the module and wherein, to bring the distal connection pad of the antenna into the encapsulation zone, the turns of the antenna contain, in the vicinity of the distal connection pad, a local bulge oriented in the direction of the chip, so as to allow said distal connection pad and the corresponding terminal of the chip to be connected inside the encapsulation zone.

4. The electronic module as claimed in claim 1, wherein the turns of the antenna pass through, on at least one side of the module, the encapsulation zone, and wherein the turns deviate locally in order to bypass bonding holes produced between the terminals of the contact interface of the chip, and the ISO connection terminals of the module.

5. The electronic module as claimed in claim 1, wherein the turns of the antenna are configured into two bands in series, namely an external band near the periphery of the module and an internal band closer to the chip, at least the internal band being provided with a bulge and a contact terminal located in the encapsulation zone, so as to make it possible to connect to the chip, during production of the module, only the internal band, or the two bands of turns.

6. The electronic module as claimed in claim 1, wherein the antenna is partially arranged under the chip, so as to bring the distal connection pad of the antenna closer to the encapsulation zone, so as to obtain a smaller encapsulation area and a shorter electrical connection between the connection pads of the antenna and the terminals of the contactless interface of the chip.

7. The electronic module as claimed in claim 1, wherein the chip is arranged in a window produced in the thickness of the substrate, so as to obtain a module the thickness of which is smaller than or about equal to the sum of the thicknesses of the chip and of the substrate.

8. A smartcard with a dual, contact and contactless communication interface, wherein it comprises an electronic module as claimed in claim 1.
